(19) United States
(12) Patent Application Publication
(10) Pub. No.: US 2008/0003533 A1
(43) Pub. Date: Jan. 3, 2008

(54) Material control system and method

(75) Inventor: Jh Kung, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/396,078

(22) Filed: Mar. 30, 2006

(51) Int. Cl. F27B 7/02

(52) U.S. Cl. 432/106

(57) ABSTRACT

A material control system and method is proposed. A user creates data of a validation control mechanism based on data about customer title attributes, types of CEM, environmental protection regulations, and classes of part numbers, and stores the created data of the validation control mechanism in a database. When the user applies for a material part number, a project design is changed, the material checklist is maintained, and a customer product menu is created by the user, a judgment module compares and judges in a real-time manner whether the material part number put down meets the requirements for the data of the validation control mechanism created in the database. After the user puts down a material part number not meeting the requirements for the data of the validation control mechanism created for the database, a prompt module gives the user a prompt and displays differences between different material part numbers.

### BACKGROUND OF THE INVENTION

1. Field of the Invention

The present invention relates to a material control system and method, and more particularly, to a material control system and method for avoiding matching a mix of different customers and different CEM part numbers.

2. Description of Prior Art

Owing to advancement of technology and the wide use of electronic, information and automated technology, there are enormous changes in manufacturing and production modes; for instance, powerful computers and machines gradually substitute for the abundant human resources which underpin the conventional manufacturing industry, and in consequence computers or machines always play an auxiliary role in different stages, say, from product development/design to shipping, and then delivering the products to customers. Although development, design and production of today are far less labor-intensive, take much less time and incur much less cost than they did over the past. Also, the market competition is becoming keener. Hence, in order to gain a considerable market share, enterprises have to spend the least amount of funds within the shortest period of time, and produce those products which meet market needs best. Accordingly, in order to get used to the highly competitive environment and capricious market needs, the enterprises should reorganize their own corporate structure and architecture as well as ensure their survival and development in the competitive market by developing high-quality, low-cost, new products quickly. An important issue here is to excel one's rivals in efficiently using related computer auxiliary equipment and taking corresponding measures in the course of product development/design and production.

Take material part number management as an example, part numbers are given with a view to achieving the following goals. First, easy identification of data: where data are voluminous, entries, such as those related to customers, goods and employees, are often repeated or identical and thus they may be mistaken for each other; hence, each piece of data has to be given a unique code which serves as the only means to the identification of that piece of data, so as to eliminate ambiguity. Second, efficient operation: where a piece of data is denoted by a title, the title is inevitably so wordy that reading, writing and inputting the piece of data turns out to be inconvenient and susceptible to error; hence, a short code streamlines operation. Thirdly, easy data organizing: “sorting” is one of the important functions of computer; where a title also functions as a “key value” for making a printout enquiry of data, the data displayed in the printout is unsorted and therefore incomprehensible, because the title does not reflect a well-organized sorting relationship. Therefore, it is necessary to perform sorting, preferably with specially designed codes.

Nevertheless, with a conventional material control system and method, like raw materials match like part numbers—a rule which is always applicable among different customers. However, this is not the case in practice. It is true that different customers may be using the same raw material, but the price can vary. Hence, it is necessary to give the customers their respective part numbers. Further, part number management keeps trade secrets and protects commercial interests between an enterprise and its customers. In this regard, the conventional method is clearly unfit for the job. Even if customers are matched with part numbers manually, the procedure will never be free of human-induced careless mistakes, bringing about the risks every enterprise has to take.

### SUMMARY OF THE INVENTION

In light of the drawbacks of the aforesaid prior art, it is a primary objective of the present invention to provide a material control system and method for creating an e-business platform designed to enable enterprises to perform real-time material control and material validation on different customer groups and different types of CEM.

Another objective of the present invention is to provide a material control system and method for providing a user with a comparison mechanism configured to stop the user from entering any non-conforming material part numbers.

Yet another objective of the present invention is to provide a material control system and method for providing a prompt mechanism for a user who wants to change materials of the same type but with different part numbers, such that, with the prompt mechanism, the user is given a prompt and informed of any difference between the replaced material and the substitute material.

In order to achieve the above objectives, a material control system of the present invention comprises a database, a judgment module, and a prompt module. The database stores at least data about types of CEM, customer title attributes, and environmental protection regulations, as well as material titles, classes of part numbers, material part numbers, and customer titles which match their respective part numbers. When a user fills in a material checklist with a material part number, the judgment module compares the entered material part number with the corresponding customer and judges whether they match or not. When a user fills in the material checklist with a material part number which does not match the customer, the prompt module gives the user a prompt and displays the differences between different material part numbers.

Given the material control system, the method for implementing the material control system comprises the steps of: first, creating the data of a validation control mechanism in accordance with various customer title attributes, types of CEM, environmental protection regulations, and classes of part numbers, and storing the data of the created validation control mechanism in the database; second, the judgment module's performing comparison and judging whether an entered material part number meets the requirements for the data of the validation control mechanism created for the database, in the course of a user's applying for a material part number, changing a project design, maintaining a material checklist, and creating a customer product menu; thirdly, the prompt module's generating a warning signal and displaying the differences between different material part numbers, when a user enters a material part number which does not meet the requirements for the data of the validation control mechanism created for the database.

Unlike a conventional material management system and method, the material management system and method of the present invention provides a user with a comparison mechanism configured to stop a user from entering a non-conforming material part number, and further provides a prompt mechanism for a user who wants to change materials of the same type but with different part numbers, such that, with the prompt mechanism, the user is given a prompt and informed of any difference between the replaced material and the substitute material.

### BRIEF DESCRIPTION OF DRAWINGS

FIG. 1 is a block diagram showing the application structure of the material control system of the present invention;

FIG. 2 is a block diagram showing the system structure of the material control system of the present invention; and

FIG. 3 is a flow diagram showing the material control method of the present invention.

### DETAILED DESCRIPTION OF PREFERRED EMBODIMENTS

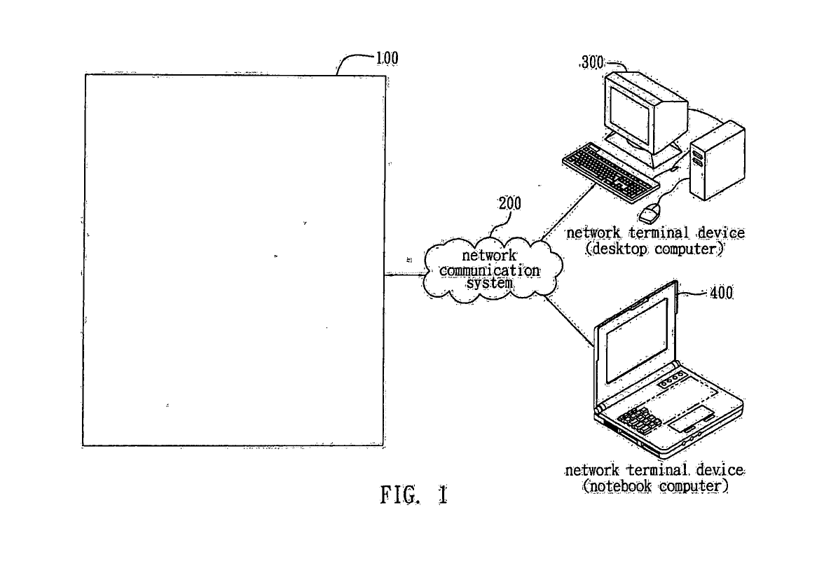

Referring to FIG. 1, in this embodiment, a material control system 100 of the present invention is used in a network communication system 200 with a master/slave structure. The material control system 100 is built and installed at a servo end of the network communication system, so as to enable a client end user equipped with a network terminal device 300 and a network terminal device 400, both having a networking function, to be engaged in interconnection with the material control system 100 built and installed at the servo end, using a browser application program and the network communication system 200, with a view to sending and receiving data, including the related data of material control. The network communication system 200 is one selected from the group consisting of the Internet, an intranet, and an extranet. The network terminal device 300 or the network terminal device 400 is one selected from the group consisting of a PC, notebook computer, and workstation. The browser application program is one of the Microsoft's Internet Explorer and the Netscape Navigator. The above-mentioned, namely the network communication system 200 with a master/slave structure, the network terminal devices, and the browser application program, belong to conventional software and hardware structures, thus their descriptions are omitted herein.

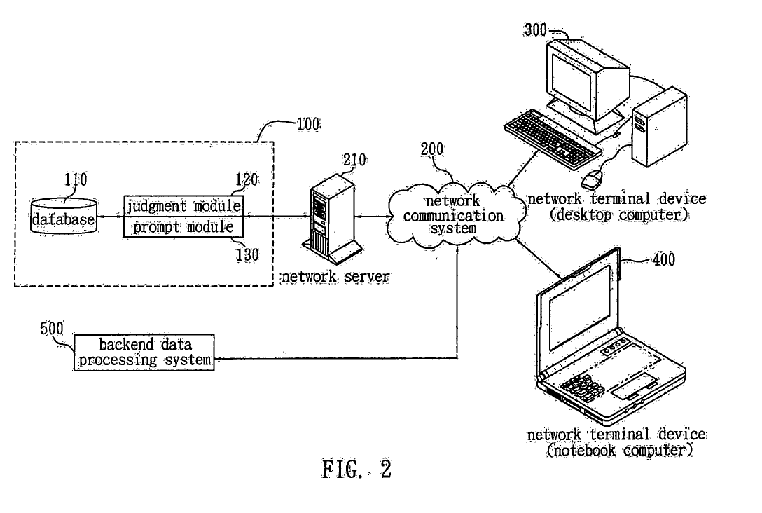

Referring to FIG. 2, the material control system 100 of the present invention works along with a network server 210. With the network server 210, the material control system 100 is engaged in interconnection with both the network terminal device 300 and the network terminal device 400, via the network communication system 200. The network server 210 also enables both the network terminal device 300 and the network terminal device 400 to respond to a user's command or meet other needs, so as to store data. In this embodiment, both the network terminal device 300 and the network terminal device 400 use their respective installed browser application programs, namely the Microsoft's Internet Explorer and the Netscape Navigator, to engage in interconnection with the material control system 100, via the network communication system 200 and the network server 210, with a view to sending, receiving and accessing data related to material part numbers. Besides, the material control system 100 further engages in interconnection with a backend data processing system 500 via the network communication system 200, so as to store in the backend data processing system 500 the material checklist related data created by means of the material control system 100. In this embodiment, the backend data processing system 500 is one of an enterprise resource planning (ERP) system and a material resource planning (MRP) system.

The material control system 100 is used for management of material part numbers, project design modification, material checklists, and customer product menus, and comprises a database 110, a judgment module 120, and a prompt module 130.

The material control system 100 stores in the database 110 data, which comprises at least a customer data table and a material part number data table, inputted by a user via the network communication system 200, using a network terminal device. In this embodiment, the database 110 is designed to be a relational database, so as to enhance the efficiency of data enquiry and search. The customer data table comprises at least fields of customer title attributes, types of CEM, environmental protection regulations, and classes of part numbers, etc. The material part number data table comprises at least fields of material titles, classes of part numbers, material part numbers, and customer title attributes corresponding to their respective part numbers etc.

Customer title attributes comprise at least data about particulars of customer identity, product specifications information, and material quotes.

CEM are divided into the following types, namely original design manufacture (ODM), original equipment manufacturer (OEM), contract electronic manufacturer (CEM), innovation design manufacturing (IDM), and a self-brand. The customer title attribute refers to a customer checklist of CEM.

The material part numbers are divided into the following classes, namely common, consign, specify, CEM, and customer unique.

With the created relational database and definitions of various attributes of the customer data table and the material part number data table, two advantages are achieved. First, erroneous application for part numbers or a mix of different customers and different part numbers can be avoided, even when there are plenty of customers. Second, once a user enters any one of the aforesaid types of data, the material control system 100 may swiftly find the corresponding data. However, it should be noted that the aforesaid data fields and the associated data tables are herein illustrated for an exemplary purpose only, and that in practice any description of them should be more definite and detailed. In addition, individual data fields may also contain other data fields or data tables, thus only those data related to material control are explained herein, for the sake of conciseness. Moreover, there are various system structures of relational databases, but the method for building the structures falls into the scope of the related prior art, thus the structures are not described herein.

At the moment when a material part number is applied for, a project design is changed, a material checklist is maintained, and a customer product menu is created, by a user, the judgment module 120 compares and judges in a real-time manner whether the material part number put down is consistent with the data in the customer data table and the material part number data table, and whether the material part number put down matches the conforming customer. In this embodiment, assuming that a manufacturer A′ is a notebook computer original equipment manufacturer (OEM), and a material A is fit for a notebook computer CPU. The original part number of the CPU made of A is 6070A0019701. The manufacturer A′ is a notebook computer original equipment manufacturer (OEM) for brand B and brand C, and produces notebook computers which adopt a CPU made of A. However, the quantity of the orders received by the company of brand B are two times that of the company of Brand C. Although both brands use a CPU made of A, the quote given by the manufacturer A′ to the company of brand B is 30% less than the quote the manufacturer A′ gives the company of brand C, as far as the CPU made of A is concerned. In order to facilitate differentiation, the part number of the CPU made of A, which is used in the notebook computers of the company of brand B, is set to 6070A0019701A, whereas the part number of the CPU made of A, which is used in the notebook computers of the company of brand C, is set to 6070A0019701B.

Referring to the above-mentioned, where a user wants to fill out a material checklist of the notebook computers of the company of brand B, the part number to be put down has to be 6070A0019701A, though the CPU made of A is adopted. Similarly, where a user wants to fill out a material checklist of the notebook computers of the company of brand C, the part number to be put down has to be 6070A0019701B, though the CPU made of A is adopted.

Once a user puts down a material part number in a material checklist, the judgment module 120 will monitor in a real-time manner the material part number inputted by the user, and judge whether the inputted material part number matches any material part number of the company of the brand (i.e. the customer). In the event of inconformity, the judgment module 120 will instantly send a message to the prompt module 130.

The prompt module 130 is configured to give a prompt to a user and display the differences between different material part numbers whenever the user puts down in a material checklist a material part number which does not match the customer concerned. Referring to the above-mentioned, once the prompt module 130 receives a message sent by the judgment module 120, the prompt module 130 will instantly search the database 10 and find out a correct material part number corresponding to the customer. In addition, the prompt module 130 further searches the database 10 and finds out a correct, matching part number, and any other data, relating to parts/components and different from a default part number, as inputted by the user, for example, a quote of the aforesaid parts and components, such that the user may judge whether the previously inputted material part number should be adopted, whether a change or a modification is required.

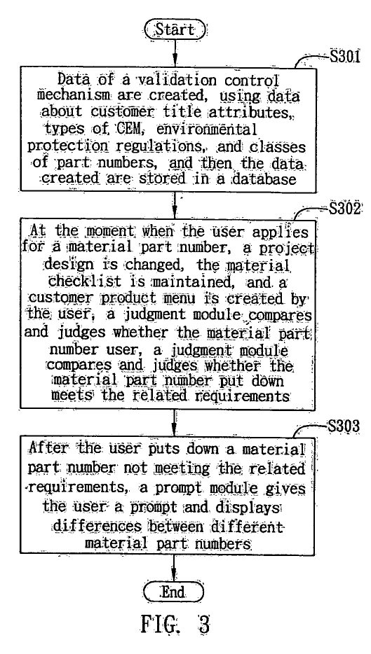

FIG. 3 is a flow diagram showing how to implement the material control method, using the aforesaid material control system 100. The flow diagram is described as follows.

In Step S301, data of a validation control mechanism are created, using data about customer title attributes, types of CEM, environmental protection regulations, and classes of part numbers, and then the data of the validation control mechanism created are stored in the database 110. Referring to the above-mentioned, in this embodiment, stored in the database 110 are data of material part number 6070A0019701A which belongs to the CPU made of A and used in the notebook computers of the company of brand B, as well as data of material part number 6070A0019701B which belongs to the CPU made of A and used in the notebook computers of the company of brand C. Then, go to Step S302.

In Step S302, at the moment when the user applies for a material part number, a project design is changed, the material checklist is maintained, and a customer product menu is created by the user, the judgment module 120 compares and judges whether the material part number put down meets the requirements for the data of the validation control mechanism created in the database 110. Referring to the above-mentioned, where the user wants to fill out a material checklist of the notebook computers of the company of brand B, the part number to be put down has to be 6070A0019701A, though the CPU made of A is adopted.

Once the user puts down a material part number in a material checklist, the judgment module 120 will monitor in a real-time manner the material part number inputted by the user, and judge whether the inputted material part number matches any material part number of the company of the brand (i.e. the customer), or, in other words, judge whether the part number inputted by the user is 6070A0019701A. In the event of inconformity, the judgment module 120 will instantly send a message to the prompt module 130. Then, go to Step S303.

In Step S303, the prompt module 130 is configured to give a prompt to the user and display the differences between different material part numbers whenever the user puts down in a material checklist a material part number which does not meet the requirements for the data of the validation control mechanism created in the database 110. Referring to the above-mentioned, once the prompt module 130 receives a message sent by the judgment module 120, the prompt module 130 will instantly search the database 10 and find out a correct material part number corresponding to the customer. In addition, the prompt module 130 further searches the database 10 and finds out a correct, matching part number, and any other data, relating to parts/components and different from a default part number, as inputted by the user, for example, a quote of the aforesaid parts and components, such that the user may judge whether the previously inputted material part number should be adopted, or judge whether the material part number should be changed or a new one should be created.

If the user wants to change the material part number or create a new one, then, after the user created or modified the related material part number using the network terminal device, the user transmits and stores in the database 110 of the material control system 100 the modified material part number and/or material checklist through the network communication system 200. Further, the user sends the aforesaid related material part number and/or material checklist to the backend data processing system 500 for data processing when necessary, using the network communication system 200.

In short, the present invention provides a material control system and method for providing a user with a comparison mechanism configured to stop the user from entering any non-conforming material part numbers, and provides a prompt mechanism for the user who wants to change materials of the same type but with different part numbers, such that, with the prompt mechanism, the user is informed of any difference between the replaced material and the substitute material.

What is illustrated above is merely the preferred embodiment of the material control method and system of the present invention. However, it is to be understood that the scope of the invention is not limited to the disclosed embodiment. On the contrary, it is intended to cover various modifications and similar arrangements. The scope of the claims, therefore, should be accorded the broadest interpretation so as to encompass all such modifications and similar arrangements.

What is claimed is:

1. A material control system for a user to use a network terminal device to execute a part number control process through a network communication system, said material control system comprising:
a database for storing at least data about customer title attributes, types of CEM, environmental protection regulations, material titles, classes of part numbers, material part numbers, and customer titles corresponding to their respective part numbers, so as to create data of a validation control mechanism;
a judgment module for comparing and judging in a real-time manner whether a part number put down in a material checklist by said user using said network terminal meets requirements for said data of said validation control mechanism created in said database; and
a prompt module for giving said user a prompt and displaying differences between different part numbers so as to enable said user to judge whether said part number is still in use after putting down said part number not meeting said requirements for said data of said validation control mechanism created in said database.

2. The material control system as recited in claim 1, wherein said customer title attributes comprise at least data about particulars of a customer identity, product specifications information, and material quotes.

3. The material control system as recited in claim 1, wherein said network terminal device is one selected from the group consisting of a workstation, personal computer (PC), notebook computer, palm-held PC, personal digital assistant (PDA), and cell phone.

4. The material control system as recited in claim 1, wherein said network communication system is one selected from the group consisting of Internet, an intranet, and an extranet.

5. The material control system as recited in claim 1, wherein said network communication system is one of a wired communication system and a wireless communication system.

6. The material control system as recited in claim 1, wherein said database is a relational database.

7. The material control system as recited in claim 1, wherein said material control system is connected with a backend data processing system via said network communication system, so as to store in said backend data processing system material checklist related data created by said material control system, wherein said backend data processing system is one of an enterprise resource planning (ERP) system and a material resource planning (MRP) system.

8. A material control method for a user to use a network terminal device to execute a part number control process through a network communication system, said material control method comprising the steps of:
enabling said user to create data of a validation control mechanism based on various data about customer title attributes, types of CEM, environmental protection regulations, and classes of part numbers, and storing said created data of said validation control mechanism in a database;
when a part number is put down in said material checklist, a project design is changed, said material checklist is maintained, and a customer product menu is created by said user, comparing and judging in a real-time manner whether said part number put down meets requirements for said data of said validation control mechanism created in said database; and
giving said user a warning signal and displaying differences between different part numbers so as to enable said user to judge whether said part number is still in use after said user puts down said part number not meeting said requirements for said data of said validation control mechanism created in said database.

9. The material control method as recited in claim 8, wherein said customer title attributes comprise at least data about particulars of a customer identity, product specifications information, and material quotes.

10. The material control method as recited in claim 8, wherein said network terminal device is one selected from the group consisting of a workstation, PC, notebook computer, palm-held PC, PDA, and cell phone.

11. The material control method as recited in claim 8, wherein said network communication system is one selected from the group consisting of Internet, an intranet, and an extranet.

12. The material control method as recited in claim 8, wherein said network communication system is one of a wired communication system and a wireless communication system.

13. The material control method as recited in claim 8, wherein said database is a relational database.

14. The material control method as recited in claim 8, further providing a backend data processing system for storing material checklist related data, wherein said backend data processing system is one of an enterprise resource planning (ERP) system and a material resource planning (MRP) system.
